(19) United States
(12) Patent Application Publication
(10) Pub. No.: US 2015/0042459 A1
(43) Pub. Date: Feb. 12, 2015

(54) RFID TRANSPONDER HAVING A PLURALITY OF MEMORY AREAS

(71) Applicants: Bruno Kiesel, Erlangen (DE); Patrick Schulz, Furth (DE)

(72) Inventors: Bruno Kiesel, Erlangen (DE); Patrick Schulz, Furth (DE)

(21) Appl. No.: 14/381,857

(22) PCT Filed: Mar. 1, 2012
(86) PCT No.: PCT/EP2012/053538

§ 371 Date: Aug. 28, 2014

(51) Int. Cl. G06K 7/10; G06K 19/073

(52) U.S. Cl. CPC G06K 7/10366; G06K 19/07309
USPC 340/10.52

(57) ABSTRACT

A read/write device (SLG) for a transponder (T) and a method for generating addresses (xUID_{—}1, . . . , xUID_n) for access to a second memory (xSP_{—}1, . . . , xSPn) of the transponder (T) that is provided for a RFID System and that includes an antenna, a processing unit, and a first memory (SP) to which a unique identification number (UID) is assigned, wherein the transponder (T) has a second memory (xSP_{—}1, . . . , xSPn) that is different from the first memory (SP) for storing further information.

### REFERENCE TO RELATED APPLICATION

This is a U.S. national stage of application No. PCT/EP2012/053538 filed 1 Mar. 2012.

### BACKGROUND OF THE INVENTION

1. Field of the Invention

The invention relates to a transponder for an RFID system, an RFID system comprising a read/write device and at least one transponder and to a method for generating an address for the transponder.

2. Description of the Related Art

The acronym RFID is derived from the English term “radio frequency identification”. In other words, it means “identification with the aid of electromagnetic waves”.

A conventional transponder consists essentially of a processing unit, an antenna and a memory. Apart from the RFID transponder, a read/write device also belongs to an RFID system. If a transponder moves into a transmission field of the read/write device, the transponder is supplied with energy via an electromagnetic coupling between an antenna of the transponder and the read/write device, being able to transmit data at the same time. In this context, pulse-coded information is edited such that it can be processed as a pure digital signal by the processing unit of the transponder.

Depending on the manufacturer of the transponder chip, a conventional transponder has a user memory of different size. Conventional sizes are 112 bytes, 256 bytes, 992 bytes or 2000 bytes. The memory is accessed in a block-orientated manner. In addition, each transponder chip has an 8-byte large unique identification number UID. This can only be read out and not overwritten. A transponder is accessed via its UID. As soon as a transponder enters into a field of a read/write device, it transmits its UID to the read/write device. It is only then that the read/write device can send write or read commands to the transponder.

Communication between the transponder and the read/write device is controlled by standardized protocols. These include, for example, the multitransponder protocol and different selection protocols for selecting an actual transponder in a field, such as the anti-collision protocols “ALOHA” or “Binary Tree”.

Currently, all applications that use a conventional transponder have access to the complete memory area of the transponder. If a transponder is to be utilized by different applications, the risk exists that an application can write data into or change data in the memory area that is already used or has been used by another application.

### SUMMARY OF THE INVENTION

It is an object of the invention to provide a transponder and an RFID system with an associated method that enable the transponder to be used more flexibly.

This and other objects and advantages are achieved in accordance with the invention by a transponder, an RFID system and a method, where the transponder is provided for the RFID system which comprises an antenna, a processing unit and a first memory, to which a unique identification number UID is allocated, where the transponder has a second memory that is different from the first memory for storing further information. A particular advantage of a further memory of the transponder lies in the fact that it provides different memories or memory areas to different applications and by this means prevents a change of data already present in the memory or even complete overwriting of the data in the memory of the transponder from occurring. In this manner, the transponder can provide a dedicated memory to various applications. Such a transponder can be used more flexibly, in consequence.

The processing unit of the transponder is configured advantageously such that the first memory can be accessed via the identification number. This makes it possible to ensure that pre-existing communication protocols of an RFID system can be used in the usual manner as before. This compatibility ensures that the transponder can be used in all RFID systems.

In a particularly preferred embodiment, the processing unit of the transponder is configured such that the second memory can be accessed via an address generated via the identification number. The address generated via the identification number of the transponder ensures that a memory or memory area of the transponder can be accessed uniquely with the particular identification number. This avoids that a read/write device addresses the wrong transponder or reads out or writes to the memory of the transponder. For the read/write device, the access to an extended memory is the same as the access to a further transponder, i.e., the generated address is equivalent to the identification number for the addressing of a transponder. Accordingly, access to the further memories or memory areas of the transponder is possible only by a selection of the transponder having the identification number or generated address.

Depending on the type of use, it is advantageous if the first memory is separated logically from the second memory. To be particularly flexible in the design of access methods to the memory or particular memory areas of the memory, the individual memories can also be physical memories separated from one another. The individual memories can have different characteristics, such as only be suitable for reading out information or else, beyond reading, also permitting writing into the memory. Other memories, in turn, can be encrypted. Furthermore, it is possible to address memories or memory areas of different size.

It is also an object of the invention to provide an RFID system comprising a read/write device and at least one transponder in accordance with the invention in which the read/write device is configured such that, an address can be generated for accessing the second memory area of the transponder via the identification number of the transponder. So that a transponder in accordance with the invention can be used, the read/write device is suitably able to access the various memories of the transponder. In addition, the read/write device is also able to read out conventional transponders or to write to these. As a result, such an RFID system can be used in a particularly versatile manner.

It is a further object of the invention to provide a method for generating an address of the second memory area of a transponder according to the invention, where via a read/write device in accordance with the invention or an application of a peripheral device coupled to a read/write device, the address of the second memory is generated from the unique identification number of the transponder via a predetermined algorithm. Such a method makes it possible for the behavior of the inventive transponder to correspond to that of a conventional transponder. In other words, only the unique identification number of the transponder, which it is possible to access the first memory area, is visible towards the outside. However, a read/write device in accordance with the invention or an application of a peripheral device coupled to a conventional read/write device is capable of generating addresses for the access to the second memory or further memory areas of the transponder according to the invention via a predetermined algorithm.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the text which follows, the invention and its embodiments will be explained in greater detail with reference to a drawing, in which:

FIG. 1 shows a memory concept of a transponder in accordance with an embodiment of the invention;

FIG. 2 shows a basic diagram which illustrates individual steps of a communication between a read/write device and a conventional transponder;

FIG. 3 shows a basic diagram that represents individual steps of a communication between a read/write device in accordance with the invention and a transponder in accordance with the invention; and

FIG. 4 is a flowchart of the method in accordance with the invention.

### DETAILED DESCRIPTION OF THE PREFERRED EMBODIMENTS

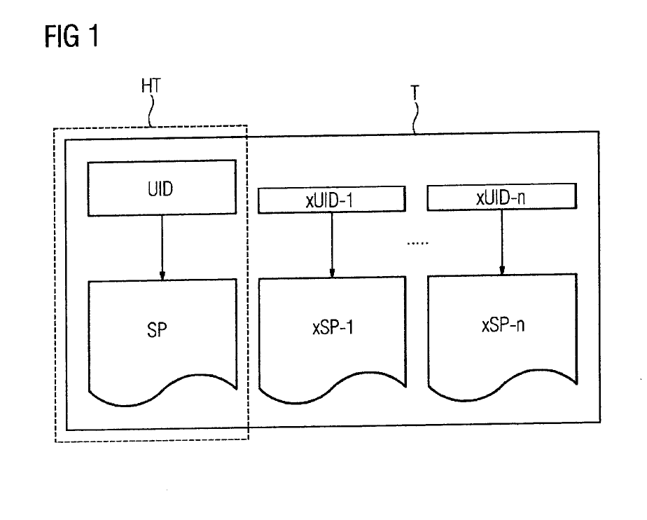

FIG. 1 illustrates an exemplary embodiment of a memory concept of a transponder T in accordance with the invention. Conventional transponders HT have an identification number UID, by which they can be identified by a read/write device SLG. A first memory SP belonging to the conventional transponder HT is addressed via the associated identification number UID. The memory concept of a conventional transponder HT is indicated by a dashed frame in FIG. 1.

In order to be able to use a transponder HT in a more versatile manner, an embodiment of the invention provides a transponder T comprising an extended memory concept, extended memories xSP_1, . . . , xSP_n representing individually addressable memories or memory areas (i.e., second memories). The individual extending memories xSP_1, . . . , xSP_n can be addressed via a unique address xUID_1, . . . , xUID_n. For the read/write device SLG, this is like addressing a further transponder T or HT which is also located within a transmission field of the read/write device SLG. The addresses of the extended memories xSP_1, . . . , xSP_n can be calculated by a read/write device SLG or an application of a peripheral device coupled to a conventional read/write device SLG by a predetermined algorithm from the identification number UID of the transponder T. A particular advantage lies in the fact that different applications relating to the same transponder T also can or may only selectively read out from or write to memories xSP_1, . . . , xSP_n especially allocated to them. In this manner, one and the same transponder T can be used by different applications.

Depending on the application environment, it is possible to use from simple up to very complex algorithms for calculating the addresses xUID_1, . . . , xUID_n. As a result, the transponder T in accordance with the invention is also suitable for use in security-related applications.

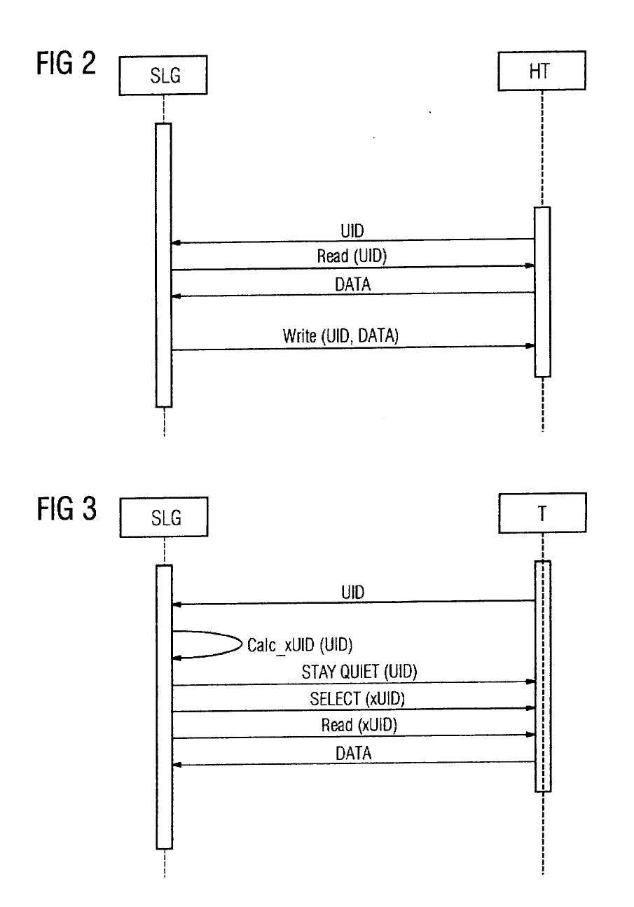

The arrows depicted in FIGS. 2 and 3 designate access steps of a read/write device (SLG) to a transponder (T).

FIG. 2 shows via a diagram the structure of a communication between a conventional read/write device SLG and a conventional transponder HT in the case of access to its memory SP.

As soon as the transponder HT enters a field of the read/write device SLG, it conveys its identification number UID to the read/write device SLG which reads the identification number of the transponder HT—Read(UID). From then on, the read/write device SLG can perform read or write accesses—Write (UID, DATA)—to the transponder HT. Standardized protocols, such as ISO_{—}15961, ISO_{—}15962, ISO_{—}15963, then coordinate the individual read or write accesses to the memory SP of the transponder HT. In this context, the read/write device SLG addresses the transponder HT selectively via its identification number UID. As soon as the transponder HT passes out of the field of the read/write device (SLG), the communication is terminated.

FIG. 3 illustrates individual communication steps of an embodiment of the transponder T in accordance with the invention via an associated read/write device SLG. In spite of an extended memory concept xSP_1, . . . , xSP_n and associated addresses xUID_1, . . . , xUID_n (extended identification numbers), the transponder T in accordance with the invention can be used in the same manner as conventional transponders. The commands currently existing for multi-tag operation are sufficient for this purpose. In this case, too, a read/write device SLG in accordance with the invention reads out an identification number UID of the transponder T in accordance with the invention. However, the read/write device SLG in accordance with the invention is configured such that, via the identification number UID of the transponder T, an address xUID_1, . . . , xUID_n (extended identification number) can be generated for accessing a further memory xSP_1, . . . , xSP_n of the transponder T. Analogously, an address xUID_1, . . . , xUID_n can be generated for accessing further memory xSP_1, . . . , xSP_n of the transponder T by an application of a peripheral device coupled to a conventional read/write device SLG. In this context, the read/write device SLG in accordance with the invention or the application of a peripheral device coupled to a conventional read/write device SLG has a predetermined algorithm by which the address of the second or extended memory xSP_1, . . . , xSP_n is generated from the unique identification number of the transponder T—Calc_xUID (UID). The algorithm determines the address or, respectively, the extended identification number xUID_1, . . . , xUID_n of the extended memory xSP_1, . . . , xSP_n, which is then accessed by the read/write device SLG. For this purpose, the identification number UID acts only as a dummy code for the extended identification number xUID_1, . . . , xUID_n, the memory area SP of the identification number UID not being accessed in the transponder T according to the invention but one of the extended memories xSP_1, . . . , xSP_n via an associated address xUID_1, . . . , xUID_n—shown in FIG. 3 via a SELECT (xUID) command.

So that the communication between the read/write device SLG and the extended memory xSP_1, . . . , xSP_n can occur smoothly, additional or further access to the memory SP of the transponder T having the identification number UID is avoided in that the read/write device SLG “ignores” the identification number UID of the transponder T. This is represented by the command STAY QUIET (UID) in FIG. 3 and supported by the present communication protocols between read/write device SLG and transponder T. For this purpose, the actual transponder T is switched off with STAY QUIET (UID) and the “new memory area” is addressed via the select command having the calculated address xUID_1, . . . , xUID_n. To the read/write device SLG, this looks like the addressing of another transponder T as in the case of multi-transponder operation.

Subsequently, the read/write device SLG accesses the transponder T or its memory xSP_1, . . . , xSP_n, respectively, with a newly calculated or generated “identification number” or address xUID_1, . . . , xUID_n. During this process, data—DATA—are read or exchanged as in the case of a conventional transponder HT.

As soon as the transponder T is removed from the field of the read/write device SLG, the transponder T in accordance with the invention is again available to other read/write devices SLG under its identification number UID. It is only those read/write devices or applications of a peripheral device coupled to a conventional read/write device SLG that can access an extended memory xSP_1, . . . , xSP_n that are capable of perceiving the transponder T in accordance with the invention as a transponder T having a number of “identities”, depending on application.

The transponder in accordance with the invention can thus be used in a versatile manner. For example, it can contain a product memory that contains data of or about origin, production, installation, etc. A further field of application could provide information on transport stations of a component provided with the transponder T, or could contain product instructions for the production of a particular component which is provided with such a transponder T.

Accordingly, the transponder T in accordance with the invention is capable of replacing a multiplicity of conventional transponders HT, the task of which it is able to handle.

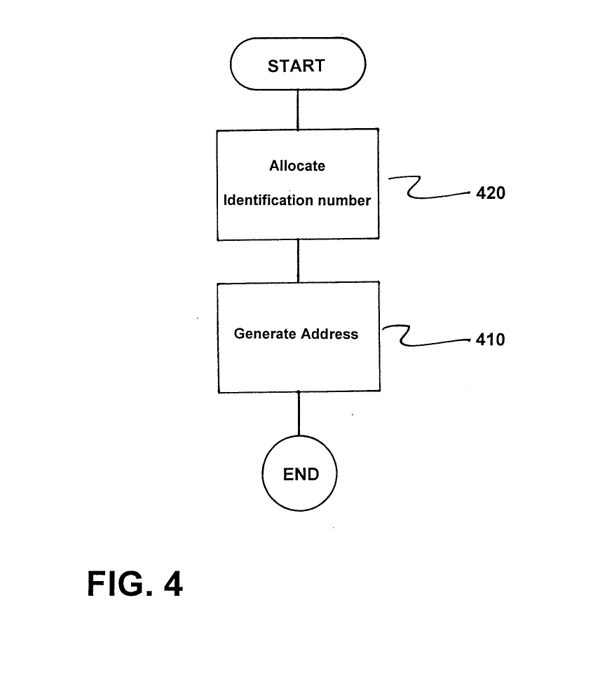

FIG. 4 is a flowchart of a method for generating an address (xUID_1, . . . , xUID_n) of a second memory area (xSP_1, . . . , xSPn) of a transponder (T). The method comprises allocating a unique identification number (UID) to a first memory (SP), as indicated in step 410. Next, an address (xUID_1, . . . , xUID_n) of the second memory (xSP_1, . . . , xSPn) is generated from the unique identification number (UID) of the transponder (T) via a predetermined algorithm utilizing either a read/write device (SLG) or an application of a peripheral device coupled to a read/write device (SLG), as indicated in step 420.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-6. (canceled)

7. A transponder for an RFID system comprising:
an antenna,
a processing unit and
a first memory having an allocated unique identification number; and
a second memory, different from the first memory, for storing further information.

8. The transponder as claimed in claim 7, wherein the processing unit is configured such that the first memory can be accessed via the identification number.

9. The transponder as claimed in claim 7, wherein the processing unit is configured such that the second memory can be accessed via an address generated by the identification number.

10. The transponder as claimed in claim 8, wherein the processing unit is configured such that the second memory can be accessed via an address generated by the identification number.

11. The transponder as claimed in claim 7, wherein the first memory is separated logically from the second memory.

12. The transponder as claimed in claim 8, wherein the first memory is separated logically from the second memory.

13. The transponder as claimed in claim 9, wherein the first memory is separated logically from the second memory.

14. An RFID system comprising:
a read/write device; and
at least one transponder;
wherein the read/write device is configured such that an address can be generated for accessing the second memory area of the transponder via the identification number of the transponder.

15. A method for generating an address of a second memory area of a transponder, comprising:
allocating a unique identification number to a first memory; and
generating an address of the second memory from the unique identification number of the transponder via a predetermined algorithm utilizing one of (i) a read/write device and (ii) an application of a peripheral device coupled to a read/write device.

16. The transponder of claim 7, wherein the second memory is encrypted.

17. An RFID system comprising:
a read/write device;
a processing unit; and
a transponder including at least a first and second memory, said first memory having an identification number;
wherein the read/write device reads the identification number from the first memory before an access procedure for the second memory is initiated.

18. The RFID system as claimed in claim 17, wherein the read/write device is a read only device.

19. The RFID system as claimed in claim 17, wherein the identification number is write protected.

20. The RFID system as claimed in claim 17, wherein data stored in the second memory is encrypted.

21. The RFID system as claimed in claim 17, wherein the processing unit generates an address to enable access to the second memory.

22. The RFID system as claimed in claim 17, wherein the first and second memories are physically separate from each other.

23. The RFID system as claimed in claim 17, wherein the first memory is read-only.

24. An article comprising:
an RFID antenna;
a processing unit;
a first memory containing a write protected unique identification number; and
at least a second memory;
wherein the unique identification number is visible to RF-ID read/write devices, the second memory is visible only to RF-ID read/write devices that exchange authorization information with said processing unit.

25. The article as claimed in claim 24, wherein the RF-ID read/write devices are read-only devices.

26. The article as claimed in claim 24, wherein the second memory is encrypted.

27. The article as claimed in claim 24, wherein the first and second memories are physically separate from each other.
